(19) United States
(12) Patent Application Publication
(10) Pub. No.: US 2020/0070863 A1
(43) Pub. Date: Mar. 5, 2020

(54) CONTROL SYSTEM AND METHOD

(71) Applicant: GE Global Sourcing LLC, Norwalk, CT (US)

(72) Inventors: Ajith Kuttannair Kumar, Erie, PA (US); Joseph Wakeman, Lawrence Park, PA (US)

(21) Appl. No.: 16/557,369

(22) Filed: Aug. 30, 2019

Related U.S. Application Data
(60) Provisional application No. 62/726,526, filed on Sep. 4, 2018.

(51) Int. Cl. B61L 27/04; B61C 5/00; B61L 25/02; F02D 41/02

(52) U.S. Cl. CPC B61L 27/04; B61C 5/00; B61L 25/025; F02D 2200/703; B61L 2201/00; B61L 25/021; F02D 2200/701; F02D 41/021

(57) ABSTRACT

A control system and method for controlling a vehicle includes monitoring movement of the vehicle as the vehicle moves along a route, and determining when the vehicle enters or leaves a designated conditional state. A first fuel efficiency weight and a first emission generation weight are determined based on the first designated conditional state. Responsive to the vehicle entering or leaving the first designated conditional state, an engine performance of the vehicle is changed to move a fuel efficiency of the vehicle toward or away from a first fuel efficiency target based on the first fuel efficiency weight, and to move a generation of an emission constituent of the vehicle toward or away from a first emission generation target based on the first emission generation weight.

### RELATED APPLICATIONS

This application relates to and claims priority benefits from U.S. Provisional Patent Application No. 62/726,526 entitled “Locomotive Control System and Method” filed 4 Sep. 2018, which is hereby incorporated by reference in its entirety.

### BACKGROUND

### Technical Field

Embodiments of the present disclosure generally relate to systems and methods for controlling the performance of vehicles.

### Discussion of Art

Vehicles, including rail vehicles, marine vessels, mining equipment, and over-the-road trucks, may move along the route according to a trip plan that may designate different operational settings at different locations along the route, different times during a trip, and/or different distances along the route. The trip plan may designate different operational settings that may optimize the performance of one or more parameters of the vehicle. For example, the optimized parameter may be a reduced travel time, reduced fuel consumption, reduced emission generation, or the like.

When one parameter of the vehicle is optimized, however, other parameters of the vehicle are compromised. For example, the vehicle may operate to reduce the total emissions generated by the vehicle. As a result, the vehicle may burn an excess amount of fuel. Alternatively, the vehicle may operate to increase the fuel efficiency of the vehicle, however, the vehicle may generate an increased amount of emissions.

### BRIEF DESCRIPTION

In one embodiment, a method for controlling a vehicle may include monitoring movement of the vehicle as the vehicle moves along a route, determining when the vehicle enters or leaves a designated conditional state, and determining a fuel efficiency weight and an emission generation weight based on the first designated conditional state. Responsive to the vehicle entering or leaving the first designated conditional state, the method may also include changing an engine performance of the vehicle that moves a fuel efficiency of the vehicle toward or away from a fuel efficiency target based on the fuel efficiency weight, and moves a generation of an emission constituent of the vehicle toward or away from an emission generation target based on the emission generation weight.

In one embodiment, a vehicle control system may include a monitoring system that may monitor movement of a vehicle as the vehicle moves along a route. The monitoring system may determine when the vehicle enters or leaves a designated conditional state. A control system may control engine performance responsive to the monitoring system determining when the vehicle enters or leaves the designated conditional state. Responsive to determining when the vehicle enters or leaves the designated condition state, the control system may determine a fuel efficiency weight and a fuel emission generation weight based on the designated conditional state, and change the engine performance of the vehicle by moving a fuel efficiency of the vehicle toward or away from a fuel efficiency target based on the fuel efficiency weight, and by moving a generation of an emission constituent of the vehicle toward or away from a emission generation target based on the emission generation weight.

In one embodiment, a method for controlling a vehicle may include monitoring movement of the vehicle as the vehicle moves along a route, and determining when the vehicle enters or leaves a designated conditional state, where the designated conditional state include one or more of a geographic area, a time, a date, or an atmospheric condition. The method may also include determining a fuel efficiency weight and an emission constituent weight based on the first designated conditional state. Responsive to the vehicle entering or leaving the designated conditional state, the method may include changing an engine performance of the vehicle that moves one of a fuel efficiency of the vehicle or generation of an emission constituent of the vehicle away from a first designated target, and that also moves the other of the fuel efficiency of the vehicle or the generation of the emission constituent toward a second designated target based on the fuel efficiency weight and the emission generation weight. Changing the engine performance may also include moving the fuel efficiency away from the first designated target by increasing fuel consumption of the vehicle and moving the generation of the emission constituent toward the second designated target by reducing the generation of the emission constituent of the vehicle.

### BRIEF DESCRIPTION OF THE DRAWINGS

The subject matter described herein will be better understood from reading the following description of non-limiting embodiments, with reference to the attached drawings, wherein below:

FIG. 1 illustrates one embodiment of a vehicle;

FIG. 2 illustrates one embodiment of a graph illustrating fuel consumption and emission generation as a function of engine performance of a vehicle;

FIG. 3 illustrates a first example of a trip plan of a vehicle;

FIG. 4 illustrates a second example of a trip plan of a vehicle;

FIG. 5 illustrates a third embodiment of a trip plan of a vehicle;

FIG. 6 illustrates a chart of controlling a vehicle as the vehicle moves in accordance with a trip plan; and

FIG. 7 illustrates a flowchart of one embodiment of a method for controlling a vehicle.

### DETAILED DESCRIPTION

One or more embodiments of the inventive subject matter described herein may include systems and methods that change an operation or performance of the engine of a vehicle based on a designated conditional state the vehicle is traveling within. The designated conditional state may be a geographic area, a time, a date, an atmospheric condition, or the like. Changing the engine performance either moves a fuel efficiency of the vehicle away from a fuel efficiency target and also moves generation of an emission constituent of the vehicle toward a emission generation target, or moves the fuel efficiency of the vehicle toward the fuel efficiency target and also moves the generation of the emission constituent away from the emission generation target.

The vehicle may move along the route according to a trip plan that may designate different operational settings at different locations along the route, different times during a trip, and/or different distances along the route. As the vehicle moves along the route, the vehicle may also leave and enter into plural different designated conditional states. The trip plan may change the operation of the vehicle based on the designated conditional state that the vehicle is moving within.

As one example, the designated conditional state may be a geographic area that has an emission generation restriction and the vehicle may need to reduce the amount of emissions generated while the vehicle is moving within the first designated conditional state. The vehicle may change the engine performance within the designated conditional state to reduce the amount of emissions generated to move the generation of emissions toward an emission generation target. Moving the generation of emissions toward the emission generation target also moves the fuel efficiency away from a fuel efficiency target.

Instead of changing the engine performance to reduce the amount of emissions generated by the vehicle to an optimum amount, the engine performance may be changed to move the generation of emissions toward a designated target and no further. For example, instead of changing the operation of the vehicle to generate the smallest amount of emissions, the operation may be changed such that the vehicle generates the smallest amount of emissions to meet the emission generation target or to remain compliant with a requirement of the designated conditional state, and as a result saves as much fuel as possible. The fuel efficiency, and the generation of one or more of the emission constituents are balanced instead of optimizing total emissions versus optimizing fuel efficiency, or arrival time, or the like. The engine performance may be changed to reduce the amount of emissions generated by the vehicle to meet an emission generation target, instead of reducing the emissions generated by the vehicle to the optimum amount of emissions that may be generated.

The vehicles described herein may include automobiles, trucks, buses, mining vehicles, rail vehicles, or the like. In one example, the vehicle may be a locomotive and formed from a single locomotive or from two or more locomotives traveling together as a consist. With respect to two or more locomotives, the locomotives may be mechanically coupled with each other, such as by couplers, or may be separate from each other but communicate with each other so that the locomotives can coordinate the respective movements of the locomotives and travel together as a locomotive system. Therefore, the route may support non-rail vehicle applications as non-rail vehicles travel on a road or route, as well as rail vehicle applications for rail vehicles that may move on a track.

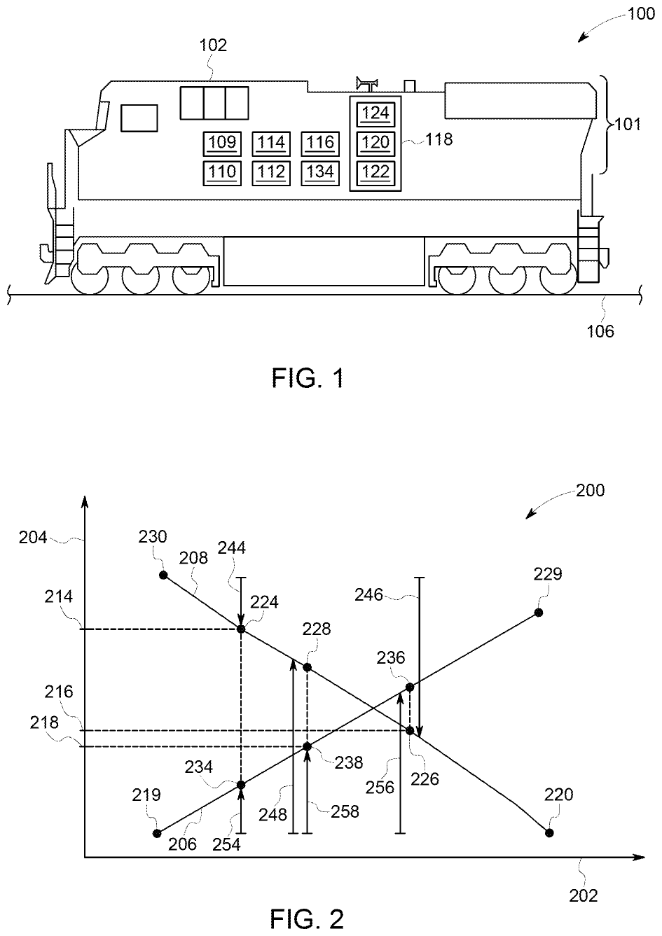

FIG. 1 illustrates one embodiment of a system 100. The system 100 includes a vehicle 102 that in one example may be a locomotive, or rail vehicle. The system 100 also includes a control system 101 that may operate to control and/or monitor movement of the vehicle 102. The vehicle 102 travels along a route 106. The vehicle 102 is shown and described as a rail vehicle, but optionally may represent another type of vehicle, as described above. Additionally, the vehicle 102 may be formed from one or more mechanically and/or logically coupled vehicles, also as described above.

The vehicle 102 may be propelled by a propulsion system 109 that represents one or more engines that may include alternators, generators, traction motors, gear boxes (holding gears that translate rotary motion created by an engine or motor into rotary motion of the wheels and/or axles of the vehicle 102), or the like. The propulsion system 109 may be supplied with fuel from a fuel source 110, such as a tank of fuel, one or more batteries, or the like. The vehicle 102 includes a brake system 112 that slows or stops movement of the vehicle 102. The brake system 112 may represent air brakes, friction brakes, regenerative brakes (e.g., that include one or more traction motors of the propulsion system), or the like. In one example the system 100 is a vehicle system that may include one or more propulsion-generating vehicles. The one or more propulsion-generating vehicles may include one or more locomotives, one or more utility trucks, etc.

The control system 101 includes a vehicle controller 114 that represents hardware circuitry that includes and/or is connected with one or more processors (e.g., one or more microprocessors, field programmable gate arrays, integrated circuits, or the like) that operate to control movement of the vehicle 102. The vehicle controller 114 may receive input from an operator onboard and/or off-board the vehicle 102 via one or more input and/or output devices 116 and, based on the input, change the propulsive force or effort (e.g., torque, power, output, tractive effort, or the like) generated by the propulsion system 109 and/or may change the braking force or effort generated by the brake system 112. The input and/or output devices 116 can represent one or more touchscreens, display devices, keyboards, pedals, levers, switches, buttons, microphones, speakers, or the like, that receive information from an operator and/or provide information to the operator.

The control system 101 also includes a monitoring system 118. The monitoring system 118 may monitor movement of the vehicle 102, different environmental conditions that the vehicle 102 may be subjected to along the route 106, or the like. The monitoring system 118 includes a controller 124 that represents hardware circuitry that includes and/or is connected with one or more processors (e.g., one or more microprocessors, field programmable gate arrays, integrated circuits, or the like) that operate to control different sensors 120, 122 of the monitoring system 118.

One of the sensors 120 may include a rotary speed sensor that measures the speed at which one or more wheels of the vehicle 102 is moving. The rotary speed sensor may also include a tachometer, for example. The other sensor 122 may include a location sensor that determines locations of the vehicle 102. For example, the location sensor can include a global positioning system (GPS) receiver, wireless transceiving equipment (that triangulates locations of the vehicle 102), or the like. Based on data provided by the location sensor, the speed at which the vehicle 102 moves along the route 106 can be determined. For example, the GPS receiver can output a speed at which the receiver determines that the vehicle 102 is moving along the route 106. In the illustrated embodiment, the monitoring system 118 includes two different sensors 120, 122. In alternative embodiments, the monitoring system 118 may include any number of sensors that may also include weather sensors (e.g., thermometers, barometers, hygrometers, rain gauges, or the like), air quality measuring devices, or the like.

In one or more embodiments, one or more other sensors of the monitoring system 118 (not shown) may be disposed off-board the vehicle 102 and may communicate with the controller 124. For example, the monitoring system 118 may receive data from a dispatch center, from one or more sensors positioned alongside the route 106, or the like.

The control system 101 may create or change a trip plan of the vehicle 102. The trip plan may designate different operational settings at different locations along one or more routes, different times during a trip, and/or different distances along the one or more routes, as described above. The trip plan may be created and/or modified off-board the vehicle 102 and may be communicated to the vehicle 102. Optionally, the trip plan may be created and/or modified onboard the vehicle 102 by an energy management system 134 onboard the vehicle 102. The energy management system 134 represents hardware circuitry that includes and/or is connected with one or more processors (e.g., one or more microprocessors, field programmable gate arrays, integrated circuits, or the like) that create and/or modify trip plans.

The energy management system 134 may examine previous trips of the same or other vehicles or vehicle systems (e.g., consists of plural vehicles), the vehicle characteristics, the route characteristics, and/or other characteristics to determine the operational settings of the vehicle 102 at different locations along one or more routes, at different distances along the one or more routes, and/or at different times for a trip that optimize fuel consumption and/or emission generation (e.g., relative to the vehicle traveling on the one or more routes for the trip at an upper speed limit or route speed). The trip plan may be communicated to the vehicle controller 114 (e.g., from a system off-board the vehicle and/or from the energy management system 134), and the vehicle controller 114 may automatically generate and communicate control signals to the propulsion system 109 and/or brake system 112. These control signals may automatically control movement of the vehicle 102 to follow the operational settings of the trip plan. Optionally, the control signals may be communicated to the operator (e.g., via the input/output device 116) to instruct the operator how to control the movement of the vehicle 102 according to the trip plan.

The control system 101 of the vehicle 102 controls engine performance of the vehicle 102 as the vehicle 102 moves along the route 106. The control system 101 may manipulate the operating point (e.g., the throttle position) of the engine of the vehicle 102, may change or manipulate the engine timing or fuel burn recipe, or the like. For example, the control system 101 may change one or more settings of the propulsion system 109, the brake system 112, or any other system that directly or indirectly interacts with the engine in order to change the performance of the engine in order for the vehicle 102 and/or each vehicle of the consist to operate according to the trip plan. In this manner, the engine performance of one or more propulsion-generating vehicles may be changed as the propulsion-generating vehicles move along the route 106.

As the vehicle 102 moves along the route 106, the vehicle 102 enters and leaves different designated conditional states. Boundaries separate the different designated conditional states and the vehicle 102 may be required to meet different compliance requirements, restrictions, limitations, or the like, while the vehicle 102 is within the boundaries of each of the designated conditional states. The designated conditional states may be geographic areas, a time and/or date, an atmospheric condition, or the like. For example, a first designated conditional state may be a geographic area (e.g., a town). For example, the vehicle 102 may be directed by a government agency or organization to reduce emissions generated by the vehicle within certain geographic areas or regions. The boundaries of the geographic area of the first designated conditional state may have a speed limitation, a sound or noise limitation, an emission limitation, or the like. Optionally, the first designated conditional state may have different speed limitations, sound limitations, or emissions limitations based on the time of day at which the vehicle 102 is within the first designated conditional state, based on the date the vehicle 102 is within the first designated conditional state, based on an atmospheric condition of the first designated conditional state as the vehicle 102 is within the first designated conditional state, or the like.

The vehicle 102 may leave the first designated conditional state and subsequently enter a different, second designated conditional state. The second designated conditional state may include one or more speed limitations, sound limitations, or emissions limitations that may be different than or the same as the speed limitations, sound limitations, and/or emissions limitations of the first designated conditional state.

As the vehicle 102 continues to move along the route 106, the vehicle 102 may enter into and leave several different designated conditional states. For example, the monitoring system 118 may determine when the vehicle 102 is approaching each designated conditional state, has entered into one of the designated conditional states, has left one of the designated conditional states, and has entered into another of the designated conditional states. To meet the different compliance requirements or restrictions of each of the different designated conditional states, the trip plan may change as the vehicle 102 moves along the route 106. For example, the control system 101 may change one or more operations of the vehicle 102, such as a timing of the engine of the propulsion system 109, an operating point of the engine of the propulsion system 109, a notch setting of the propulsion system 109, a brake setting of the vehicle 102, or the like. In one or more embodiments, the control system 101 may change a notch or brake setting of two or more vehicles 102 of a consist to change the engine performance of each vehicle 102 within the consist. In one example the vehicles of the consist each change engine performance in a similar manner in response to a conditional state. In another example, the vehicles of the consist each change engine performance in a different manner in response to a conditional state. In this manner, a first vehicle in a consist may decrease emission generation, while a second vehicle increases emission generation in response to a conditional state. As an example, for a rail vehicle having over a hundred cars and plural propulsion-generating vehicles, a first locomotive at the front of the rail vehicle reaches an incline before a second locomotive at the back of the consist. Consequently, the first locomotive has a first fuel efficiency weight based on the first conditional state of the incline, and the control system may increase fuel consumption accordingly. Meanwhile, the second locomotive has a second fuel efficiency weight based on the second conditional state of being on flat ground, and consequently decreases fuel consumption. Thus, plural propulsion-generating vehicles of a consist may have different fuel efficiency weights, and emission generation weights to provide different outputs based on the conditional state of each individual propulsion-generating vehicle.

The vehicle 102 operates as a function of at least fuel, horsepower, time, and emissions. One example of a representative objective function that may represent a control formulation of the vehicle may be:

$$( Eq . 1 ) \\ {α}_{1} {\int }_{0}^{{t}_{f}} Fuel ( u ( t ) ) dt + {∝}_{2} {\int }_{0}^{{t}_{f}} {\dot{u} ( t )}^{2} dt + {∝}_{3} {t}_{f} + {α}_{4} {{\int }^{{t}_{f}}}_{0} Emissions ( u ( t ) ) dt$$

The coefficient α1 may be a fuel efficiency weight that represents the fuel consumption of the vehicle 102 and the coefficient α4 may be a emission generation weight that represents the generation of an emission constituent by the vehicle 102 as the vehicle 102 moves along the route 106 at a continuous or substantially continuous notch position u(t). In Equation Eq. 1, the coefficient α2 represents horsepower rate of change of the vehicle, and the coefficient α3 represents time. The emission generation weight represented by the coefficient α4 may represent an individual emission or cumulative emissions of any combination produced in the form of oxides of nitrogen (NOₓ), carbon oxides (COₓ), hydrocarbons (HC), or particulate matter (PM). Other emissions may include, but are not limited to, electromagnetic emissions, such as a limit on radio frequency (RF) power output, noise produced by the vehicle as a limit on decibels (dB) sound output, or the like. Additionally or alternatively, the Equation Eq. 1 may include one or more additional coefficients for two or more individual emissions. For example, a coefficient α4 may represent carbon oxide emissions, a different coefficient α5 may represent particulate matter (PM), and another coefficient α6 may represent noise emissions.

The coefficients of the linear combination depend on the importance (weight) given to each term. The importance given to each term may be based on the designated conditional state through which the vehicle 102 is moving. For example, there may be an emission limitation in one designated conditional state. The coefficient α4 representing the generation of emissions (the emission generation weight) may be given a weight (e.g., a value) that is greater than a weight given to the coefficient α1 representing the fuel consumption (the fuel efficiency weight). When the vehicle 102 is within the designated conditional state, it may be more important that the vehicle 102 reduce an amount of generated emissions than the fuel efficiency of the vehicle 102. In another example, there may be a speed limitation in another designated conditional state. The coefficient α1 representing the fuel consumption may be given a weight that is greater than a weight given to the coefficient α4 representing the generation of emissions. When the vehicle 102 is within the second designated conditional state, it may be more important that the vehicle 102 adhere to a speed limit than an amount of emissions the vehicle 102 may generate.

Changing the engine performance of the vehicle 102 changes an amount of fuel that the vehicle 102 consumes as well as an amount of an emission constituent that the vehicle 102 may generate. The emission constituent may be oxides of nitrogen, carbon oxides, particulate matter, sound emissions, or any combination of two of more as described above. The control system 101 may change the engine performance such that fuel consumption by the vehicle 102 moves toward a designated fuel efficiency target (e.g., the vehicle 102 operates more fuel efficiently). Moving the fuel consumption of the vehicle 102 toward the fuel efficiency target also moves the generation of emissions by the vehicle 102 away from a designated emission generation target (e.g., the vehicle 102 generates a greater amount of emissions). Alternatively, the control system 101 may change the engine performance such that the fuel consumption by the vehicle 102 moves away from the fuel efficiency target (e.g., the vehicle 102 operates less fuel efficiently), which also moves the generation of emissions by the vehicle 102 toward the designated emission generation target (e.g., the vehicle 102 generates a lesser amount of emissions).

FIG. 2 illustrates one embodiment of a graph 200 illustrating fuel consumption and emission generation as a function of notch setting of the vehicle 102. The graph 200 is for illustrative purposes only and illustrates one example of a relationship between the fuel consumption and the generation of emissions by the vehicle 102 based on the notch setting of the vehicle 102 (e.g., the engine performance). A horizontal axis 202 of the graph 200 indicates a notch setting of the propulsion system 109, and a vertical axis 204 indicates a relative scale of fuel usage and emission generation by the vehicle 102. Fuel line 206 represents the fuel consumption of the vehicle 102 and an emissions line 208 represents the generation of an emission constituent (e.g., oxides of nitrogen, carbon oxides, particulate matter, noise, or the like). Optionally, the graph 200 may include plural different emissions lines (not shown) that may represent the different emissions (e.g., nitro oxides, carbon oxides, particulate matter, sound, or the like) that the vehicle 102, or that the plural vehicles 102 of a consist, may generate. In example embodiments where a consist of plural vehicles is provided, each vehicle may have an individual, different emission generation weight associated therewith, may each have the same emission generation weight associated therewith, or may have an emission generation weight for the consist and emission generation of each vehicle in the consist is determined accordingly. In this manner, each vehicle may have an identical emission generation compared to another vehicle in the consist, or may have a different emission generation compared to another vehicle in the consist.

A point 219 of the fuel line 206 indicates the optimum fuel consumption by the vehicle 102 and point 229 indicates an increased amount of fuel consumption by the vehicle 102. A point 220 of the emissions line 208 indicates an optimum amount of emissions generated by the vehicle 102 and a point 230 indicates an increased amount of emissions generated by the vehicle 102. The vehicle 102 may change operations of the engine based on the designated conditional state through which the vehicle 102 is traveling. More specifically, the vehicle 102 may change operations off the engine based on the fuel efficiency weight and emission generation weight of a given designated conditional state. Referring to the Equation Eq. 1, the coefficients representing both the fuel consumption (e.g., α1) and the generation of emissions (e.g., α4) may be given different weights (e.g., values) of importance based on the designated conditional states and one or more restrictions or limitations of the designated conditional states.

Instead of changing the engine performance to optimize the fuel efficiency (e.g., to reach the point 219) or to optimize the generation of emissions (e.g., to reach the point 220), the engine performance may be changed based on the weight given to each coefficient to move one of the factors (e.g., fuel efficiency, emissions, travel time, HP, or the like) toward a designated target. For example, the control system 101 may change one or more operations of the vehicle 102 only to move the fuel consumption by the vehicle 102 or the generation of emissions by the vehicle 102 toward a designated target by an amount needed. The engine performance may be changed to reduce the emissions generated by the vehicle 102 to meet an emission generation target, instead of reducing the emissions generated by the vehicle 102 to the optimum reduced amount of emissions that may be generated (e.g., point 220). Additionally, the amount of emissions that are generated may be reduced while the amount of fuel the vehicle 102 may consume increases. Specifically, in an example, the control system may automatically stop reduction in the generation of the emission constituent of the vehicle upon reaching the emission generation target, even though greater reduction may be achieved by the engine.

In one example, in a first designated conditional state indicated by horizontal line 214, the vehicle 102 may need to reduce the generation of emissions by an amount 244 to meet a designated emissions target at a point 224 indicating a first threshold value (e.g., to move the generation of emissions toward an emission generation target), or emission generation threshold. For example, the amount 244 of emissions generated by the vehicle 102 operating in the first designated conditional state is less than the increased amount of emissions that may be generated by the vehicle 102 (e.g., the point 230) and is also greater than the optimum reduced amount of emissions that may be generated by the vehicle (e.g., the point 220). Reducing the generation of emissions to the designated emissions target at the point 224 also increases the fuel consumption to a corresponding point 234, thereby moving the fuel efficiency away from a fuel efficiency target (e.g., the optimum decreased fuel efficiency at the point 219) by an amount 254. For example, the generation of emissions may be reduced to meet the reduced amount at point 224; however, the emission generation is not reduced to the optimum reduced amount of emissions at point 220. In this manner the control system 101 prevents the emission generation from reducing below the emission generation threshold during or within the first designated conditional state based on the emission generation weight.

The vehicle 102 may leave the first designated conditional state and subsequently enter a second designated conditional state indicated by horizontal line 216. In such an example, the fuel efficiency target of the first designated conditional state may be a first fuel efficiency target, and the fuel efficiency weight may be a first fuel efficiency weight. In this manner, in the second designated conditional state includes a second fuel efficiency target, and second fuel efficiency weight. Similarly, in the first designated conditional state the emission generation target may be a first emission generation target while the emission generation weight may be a first emission generation weight. To this end, in the second designated conditional state 216, a second emission generation target, and second emission generation weight are provided.

As an example, the second designated conditional state 216 may include an emission restriction such that the vehicle 102 may need to reduce the amount of emissions that are generated by an amount that is greater than the emissions restriction of the first designated conditional state 214. For example, the vehicle 102 may need to change an operation of the vehicle 102 to reduce the generation of emissions by an amount 246 to move toward a new, or second emission generation target at point 226 indicating a second threshold value that is greater than the first threshold value at the point 224. Reducing the generation of emissions to the point 226 increases the fuel consumption to a corresponding point 236, thereby moving the fuel efficiency further away from the optimum reduced fuel consumption (e.g., point 219) by an amount 256. The generation of emissions may be reduced to meet the second emission generation target reduced amount at point 226.

The vehicle 102 may leave the second designated conditional state and subsequently enter a third designated conditional state indicated by horizontal line 218. The third designated conditional state 218 may include a speed reduction such that the vehicle 102 may reduce the speed of the vehicle 102, thereby reducing the fuel consumption of the vehicle 102. For example, the vehicle 102 may move the fuel consumption toward a fuel efficiency target at a point 238 by an amount 258 that is more fuel efficient (e.g., is closer to the optimized reduced fuel efficiency point 219) than the vehicle 102 operating in the second designated conditional state 216. Reducing the fuel consumption to the designated fuel efficiency target at point 238 increases the generation of emissions to a corresponding point 228, thereby moving the generation of emissions away from the optimum reduced amount of emissions generated (e.g., point 220) by an amount 248.

In one example the designated target reduced amount at point 238 represent a fuel consumption threshold as determined based on the fuel efficiency weight. In such an example, the fuel consumption may be reduced to meet the fuel consumption threshold at point 238; however, the control system 101 prevents the reduction of fuel consumption past the fuel consumption threshold. For example, the fuel consumption is not reduced to the point 219 indicating the optimum reduced amount of fuel consumed by the vehicle 102. In another example, the vehicle 102 may have a first fuel consumption threshold based on the first designated conditional state the 214, while the vehicle 102 has a second fuel consumption threshold based on the second designated conditional state 216, and the vehicle 102 has a third fuel consumption threshold based on a third designated conditional state 218. The first fuel consumption threshold, second fuel consumption threshold, and third fuel consumption threshold may all be the same threshold, such as represented by point 238, each may have a different threshold where only one is represented by point 238, or two may have the same threshold with the third being a different amount. This includes the first fuel consumption threshold being greater than the second and third fuel consumption thresholds, or the first fuel consumption threshold being less than the second and third fuel consumption thresholds. In this manner, the fuel consumption thresholds for each designated conditional state are based on the fuel efficiency weight determined for the particular designated conditional state.

In an alternative embodiment, the vehicle 102 may be moving within a different designated conditional state that includes an emissions reduction requirement. The vehicle 102 may change the engine performance to move the reduction of emissions toward an emission generation target, however the fuel consumption may remain substantially unchanged and may not also move away from a fuel consumption target. For example, the vehicle 102 may be operating under one or more conditions that may reduce one of emission generation, fuel consumption, noise generation, or the like, without also negatively impacting another of the fuel efficiency, travel time objection, or the like. Additionally or alternatively, one of the emission constituents (e.g., noise, EMI, particulate matter, oxides, or the like) may be reduced or may move toward a first designated target without also moving the fuel efficiency, trip time, or another of the emission constituents away from a second designated target. In this manner, the vehicle when in the first conditional state may have a first emission generation threshold, when in a second conditional state a second emission generation threshold, and in a third conditional state a third emission generation threshold. These thresholds may be different or the same similar to the fuel consumption thresholds. These emission generation thresholds are also based on the emission generation weight. In each instance, the control system 101 prevents the generation of the emission constituent less than the emission generation threshold during or within the designated conditional state, even though the particular emission generation threshold is not an optimum emission generation for the vehicle. In this manner, the control system 101 is configured to stop reduction in a generation of the emission constituent of the vehicle upon reaching an emission generation target based on the emission generation weight.

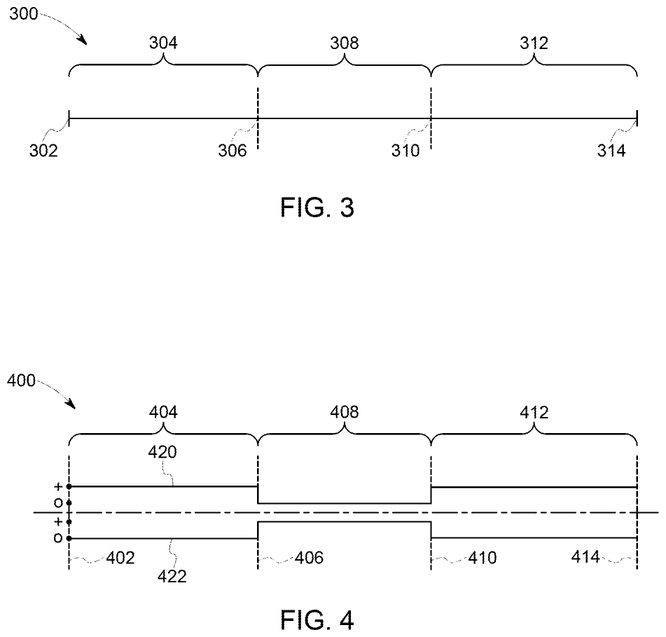

FIG. 3 illustrates one example of an illustrated trip plan 300 of the vehicle 102. The vehicle 102 moves along the route 106 between a start location 302 and an end location 314. Between the start location 302 and the end location 314, the vehicle 102 moves through a first designated conditional state 304, a second designated conditional state 308, and a third designated conditional state 312. In one example, the first designated conditional state 304 may be a geozone or a geographic area that has no restrictions or limitations of the generation of emissions but does include a speed limitation. For example, the control system 101 may change the operating point or position of the throttle of the propulsion system 109, may change the notch setting of the propulsion system 109 or a brake setting of the brake system 112 to reduce the speed of the vehicle 102 to meet a designated fuel efficiency target. Referring to Equation Eq. 1, the trip plan may be created with the coefficient α4 (e.g., emission generation weight) having a weight or importance of 0 (e.g., emissions are of little importance and are not considered within the first designated conditional state 304) and with the coefficient α1 (e.g., fuel efficiency weight) having a weight or importance of 5 (e.g., fuel efficiency is important). Improving the fuel efficiency of the vehicle 102 such that the fuel efficiency of the vehicle 102 moves toward a fuel efficiency target moves the generation of emissions away from an emission generation target (e.g., the vehicle 102 generates a greater amount of emissions).

The monitoring system 118 monitors the movement of the vehicle 102 and determines when the vehicle 102 leaves the first designated conditional state 304 and subsequently enters the second designated conditional state 308. A boundary line 306 separates the first designated conditional state 304 from the second designated conditional state 308. The boundary line 306 may be a boundary between different towns, counties, states, restricted areas, environmentally protected areas, or the like. The second designated conditional state 308 may be a different geographic area that has an emissions restriction. For example, the second designated conditional state 308 may have restrictions on an amount of particulate matter and oxide emissions that the vehicle 102 can expel. Optionally, the emissions restriction may depend on the time of day, the date, the time of year, or the like, that the vehicle 102 moves through the second designated conditional state 308. Responsive to the vehicle 102 crossing the boundary line 306 and entering into the second designated conditional state 308, the control system 101 changes one or more settings of the vehicle 102 in order to change the trip plan of the vehicle 102. For example, the control system 101 may change the notch setting of the propulsion system 109 to reduce the amount of emissions generated by the vehicle within the second designated conditional state 308 toward a designated emission generation target. Moving the generation of emissions toward the designated emission generation target also moves the fuel efficiency of the vehicle 102 away from a fuel efficiency target (e.g., the vehicle 102 is less fuel efficient).

The monitoring system 118 monitors the movement of the vehicle 102 and determines when the vehicle 102 leaves the second designated conditional state 308 and subsequently enters the third designated conditional state 312. A boundary line 310 separates the second and third designated conditional states 308, 312, respectively. The third designated conditional state 312 may have a fuel efficiency restriction and no emissions restriction. Responsive to the vehicle 102 crossing the boundary line 310 and entering into the third designated conditional state 312, the control system 101 changes one or more settings of the vehicle 102 to change the trip plan of the vehicle 102. For example, referring to Equation Eq. 1, the trip plan may be changed with the coefficient α4 (e.g., emission generation weight) having a weight or importance of zero (0) (e.g., emissions are of little importance and are not considered within the third designated conditional state 312) and with the coefficient α1 (e.g., fuel efficiency weight) having a weight or importance of five (5) (e.g., fuel efficiency is important). Improving the fuel efficiency of the vehicle 102, such that the fuel efficiency of the vehicle 102 moves toward a fuel efficiency target, moves the generation of emissions away from an emission generation target (e.g., the vehicle 102 generates a greater amount of emissions).

FIG. 4 illustrates another example of an illustrated trip plan 400 of the vehicle 102. The vehicle 102 moves along the route 106 between a start location 402 and an end location 414, and moves through first, second, and third designated conditional states 404, 408, 412 therebetween. A line 420 indicates the weight (or value of importance) given to the coefficient α1 (e.g., fuel efficiency weight) between the start and end locations 402, 414, and a line 422 indicates the weight (or value of importance) given to the coefficient α4 (e.g., emission generation weight) between the start and end locations 402, 414. Referring to Equation Eq. 1, the fuel efficiency of the vehicle 102 (e.g., the coefficient α1) has a weight or importance that is greater than zero (0) at the start location 402 and within the first designated conditional state 404. Alternatively, the generation of emissions of the vehicle 102 has little or no importance (e.g., the coefficient α4 has a weight of zero). The control system 101 may direct the propulsion system 109 of the vehicle 102 to operate to move a fuel efficiency of the vehicle 102 toward a designated fuel efficiency target. Moving the fuel efficiency of the vehicle toward the designated fuel efficiency target also moves the generation of emissions away from a designated emission generation target.

The weight or value of the coefficients α1 and α4 remain substantially the same, or static, while the vehicle 102 is moving within the first designated conditional state 404. The monitoring system 118 monitors the movement of the vehicle 102 and determines when the vehicle 102 leaves the first designated conditional state 404 and subsequently enters the second designated conditional state 408 at a boundary line 406. Responsive to the vehicle 102 crossing the boundary line 406 and entering the second designated conditional state 408, the control system 101 changes one or more operations or settings of the vehicle 102 to change the trip plan of the vehicle 102 based on the limitations or restrictions of the second designated conditional state 408.

Referring to Equation Eq. 1, the weight of the coefficient α1 (e.g., the fuel consumption of the vehicle 102) represented by the line 420 decreases, and the weight of the coefficient α4 (e.g., the generation of emissions by the vehicle 102) represented by the line 422 increases at the boundary line 406. For example, the fuel consumption is less important when the vehicle 102 is operating to meet the restrictions of the second designated conditional state 408 than when the vehicle 102 is operating to meet the restrictions of the first designated conditional state 404. Additionally, the generation of emissions may be more important when the vehicle 102 is operating to meet the restrictions of the second designated conditional state 408 than when the vehicle 102 is operating to meet the restrictions of the first designated conditional state 404. Optionally, the generation of oxides of nitrogen may be more important than the generation of carbon oxides, or the generation of a combination of nitrogen and carbon oxides may be more important than the generation of noise within the second designated conditional state 408. Additionally or alternatively, the weight of the coefficient α4 may be based on one or more of the emission constituents, a combination of two or more of the emission constituents, the cumulative emissions generated, or the like.

In one example, the weight of importance of the coefficient α1 represented by the line 420 may change from a weight (e.g., value of importance) of five (5) to a weight of zero (0) responsive to the vehicle 102 leaving the first designated conditional state 404 and entering the second designated conditional state 408. Additionally, the weight of the coefficient α4 represented by the line 422 may change from a weight of zero (0) to a weight of five (5) responsive to the vehicle 102 leaving the first designated conditional state 404 and entering the second designated conditional state 408.

As the vehicle 102 moves along the route 106, the vehicle 102 subsequently leaves the second designated conditional state 408 and enters into the third designated conditional state 412 at a boundary line 410. In the illustrated embodiment, the weight or importance of the coefficient α1 represented by the line 420 may change from a weight of zero (0) to a weight of five (5), or any alternative value, responsive to the vehicle 102 leaving the second designated conditional state 408 and entering the third designated conditional state 412. Additionally, the weight of the coefficient α4 represented by line 422 may change from a weight of five (5) to a weight of zero (0) responsive to the vehicle 102 leaving the second designated conditional state 408 and entering the third designated conditional state 412.

In an alternative embodiment, both of the coefficients α1 and α4 may have a weight or importance with the weight or importance of one of the coefficients α1 or α4 is greater than the other. For example, both of the coefficients α1 or α4 may have some weight or importance. In one example, the coefficient α1 may have a weight of 15 and the coefficient α4 may have a weight of 40 in a first designated conditional state. Responsive to the vehicle 102 entering a second designated conditional state, the weight of the coefficient α1 may decrease from the weight of 15 to a weight of 10, and the weight of the coefficient α4 may increase from the weight of 40 to a weight of 45. Alternatively, the weight of the coefficient α1 may increase from the weight 15 to a weight of 20, and the weight of the coefficient α4 may decrease from the weight of 40 to a weight of 35. Optionally, the weight of the coefficient α1 may be greater than the weight of the coefficient α4, and the weight of the coefficient α1 may increase as the vehicle 102 enters the second designated conditional state to move toward a first designated target (e.g., a fuel efficiency target) and the weight of the coefficient α4 may decrease to move away from a second designated target (e.g., an emission generation target).

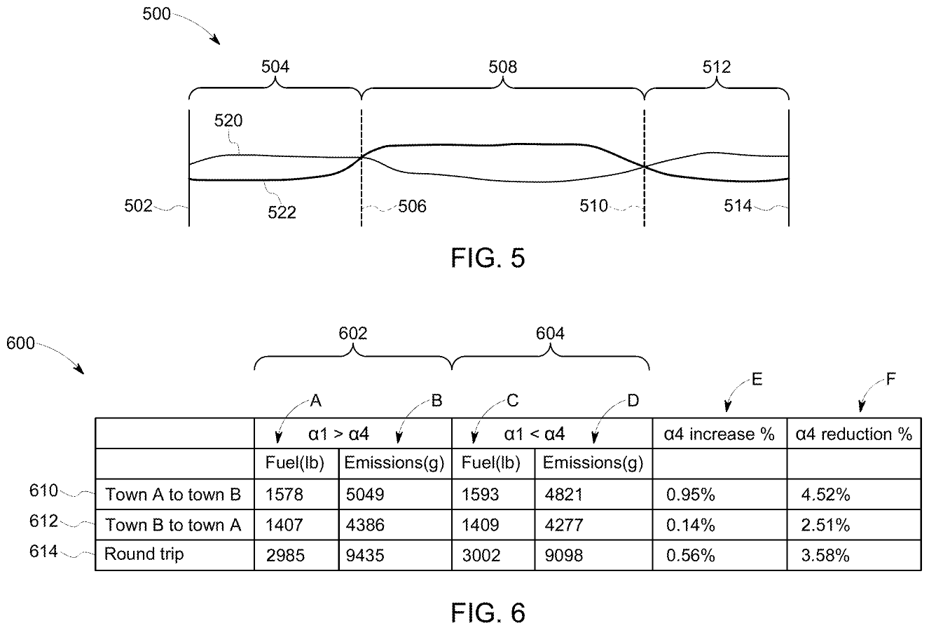

FIG. 5 illustrates another example of an illustrated trip plan 500 of the vehicle 102. The vehicle 102 moves along the route 106 between a start location 502 and an end location 514, and moves through first, second, and third designated conditional states 504, 508, 512 separated by boundary lines 506, 510, respectively, therebetween. A line 520 indicates the weight (or value of importance) given to the coefficient α1 (e.g., referencing the fuel consumption) between the start and end locations 502, 514, and a line 522 indicates the weight (or value of importance) given to the coefficient α4 (e.g., referencing the generation of emissions) between the start and end locations 502, 514. Referring to Equation Eq. 1, the fuel efficiency of the vehicle 102 has a weight or importance that is greater than the weight or importance of the generation of emissions within the first designated conditional state 504. Instead of the weight or value of each of the corresponding coefficients α1 and α4 remaining substantially the same or static within the first designated conditional state 504, as illustrated in FIG. 4, the weight of each of the coefficients α1 and α4 continuously change based on the location of the vehicle 102 within the first designated conditional state 504. For example, the Equation Eq. 1 continuously changes as the vehicle 102 moves between the start location 502 and the boundary line 506. As a result, the control system 101 may continuously change one or more settings of the vehicle 102 to operate according to the continuously changing trip plan of the vehicle 102.

FIG. 6 illustrates a table 600 of controlling a vehicle as the vehicle 102 moves in accordance with a trip plan. A row 610 illustrates an example of the performance of the vehicle 102 for a first part of a trip as the vehicle 102 travels from a first town A to a second town B. A row 612 illustrates an example of the performance of the vehicle 102 for a second part of the trip as the vehicle 102 returns from the second town B to the first town A. A row 614 illustrates the overall round-trip performance of the vehicle 102.

As the vehicle 102 travels from town A to town B or from town B to town A, the vehicle 102 enters into and leaves different designated conditional states. In one example, a first designated conditional state 602 may include a speed limitation. Referring to the Equation Eq. 1 the coefficient α1 referencing the fuel consumption of the vehicle 102 may have a weight or importance that is greater than the weight or importance of the coefficient α4 referencing the generation of emissions. Alternatively, a second designated conditional state 604 may include an emissions limitation and the coefficient α4 may have a weight that is greater than a weight of the coefficient α1. As indicated in the table 600 in the row 610 from town A to town B, the vehicle 102 generates a greater amount of emissions but burns less fuel when the vehicle 102 is moving within the first designated conditional state 602 compared to when the vehicle 102 is moving within the second designated conditional state 604. For example, the fuel consumption by the vehicle 102 in the first designated conditional state 602 (e.g., column A) is less than the fuel consumption by the vehicle 102 in the second designated conditional state 604 (e.g., column C). Additionally, the generation of emissions by the vehicle 102 in the first designated conditional state 602 (e.g., column B) is greater than the generation of emissions by the vehicle 102 in the second designated conditional state 604 (e.g., column D).

In the first designated conditional state 602, moving the fuel consumption toward a fuel efficiency target (e.g., the vehicle 102 operates more fuel efficiently) moves the generation of emissions away from an emission generation target (e.g., the vehicle 102 generates a greater amount of emissions). Alternatively, in the second designated conditional state 604, moving the generation of emissions toward the emission generation target (e.g., the vehicle 102 burns a lesser amount of emissions) moves the fuel efficiency away from the fuel efficiency target (e.g., the vehicle 102 operates less efficiently).

In one embodiment, the vehicle 102 may operate according to a trip plan in which the weight of both of the coefficients α1 and α4 may be different for the trip from town A to town B (e.g., row 610) than the coefficients α1 and α4 for the trip from town B to town A (e.g., row 612). For example, the vehicle 102 may travel from town B to town A during a different time of day, different day of the week, or the like, then when the vehicle 102 travels from town A to town B. The different time of day, the different day of the week, or the like, may include a different speed limitation or generation of emissions restriction. For example, the first and second designated conditional states during the trip in row 610 may be different than the first and second designated conditional states during the trip in row 612. In the illustrated example of table 600, the weight of the coefficient α1 may be greater than the weight of the coefficient α4 as the vehicle moves within the first designated conditional state 602. However, the weight of the coefficient α1 in row 610 may be greater than or less than the weight of the coefficient α1 in row 612. Additionally, the weight of the coefficient α4 in row 610 may be greater than or less than the weight of the coefficient α4 in row 612.

As indicated in the row 612 of the trip from the town B to the town A (e.g., the return trip), the vehicle 102 generates a greater amount of emissions but burns less fuel when the vehicle 102 is moving within the first designated conditional state 602 compared to when the vehicle 102 is moving within the second designated conditional state 604. For example, the fuel consumption by the vehicle 102 in the first designated conditional state 602 (e.g., column A) is less than the fuel consumption by the vehicle 102 in the second designated conditional state 604 (e.g., column C). Additionally, the generation of emissions by the vehicle 102 in the first designated conditional state 602 (e.g., column B) is greater than the generation of emissions by the vehicle 102 in the second designated conditional state 604 (e.g., column D).

As the vehicle 102 travels from town A to town B (e.g., row 610) and from town B to town A (e.g., row 612), moving the fuel consumption toward a fuel efficiency target (e.g., the vehicle 102 operates more fuel efficiently) in the first designated conditional state 602 moves the generation of emissions away from an emission generation target (e.g., the vehicle 102 generates a greater amount of emissions). Additionally, in the second designated conditional state 604, moving the generation of emissions toward the emission generation target (e.g., the vehicle 102 generates a lesser amount of emissions but does not generate an optimum reduced amount of emissions) moves the fuel efficiency away from the fuel efficiency target (e.g., the vehicle 102 operates less fuel efficiently).

The row 614 illustrates the performance of the vehicle 102 over the round trip of the vehicle 102. For example, column A indicates the total amount of fuel the vehicle 102 consumed and column B indicates the total amount of emissions generated by the vehicle 102 when the vehicle 102 was operating according to the trip plan within the first designated conditional state 602. Additionally, column C indicates the total amount of fuel the vehicle 102 consumed and column D indicates the total amount of emissions generated by the vehicle 102 when the vehicle 102 was operating according to the trip plan within the second designated conditional state 604.

As a result of the vehicle 102 changing the engine performance to operate according to the trip plan within the first designated conditional state 602 and within the second designated conditional state 604 from the town A to town B, the total fuel consumption increases (e.g., column E) and the generation of emissions decreases (e.g., column F). Additionally, changing the engine performance to operate within the first and second conditional states 602, 604 from the town B to town A increases the total fuel consumption (e.g., column E) and decreases the generation of emissions (e.g., column F). Changing the engine performance between the trip of row 610 (from town A to town B) and the trip of row 612 (from town B to town A) also changes a total amount of fuel consumed by the vehicle 102 and changes a total amount of emissions generated by the vehicle 102. For example, the vehicle 102 consumed more fuel (e.g., operated less fuel efficiently) from the town A to town B (e.g., row 610) than on the route from town B to town A (e.g., row 612). Additionally, the vehicle 102 generated more emissions (had a smaller percentage reduction) on the trip from town B to town A (e.g., row 612) than on the trip from town A to town B (e.g., row 610).

In the illustrated example, the vehicle 102 overall reduced the amount of emissions that were generated by the vehicle by about 3.5% while only increasing the fuel consumption by about 0.5%. For example, moving the amount of emissions generated toward an emission generation target (e.g., a target and not an optimized reduced amount of emissions) moves the fuel efficiency away from a fuel efficiency target (e.g., increases the fuel consumption to meet the emission generation target). In an alternative embodiment, the control system 101 may change one or more settings of the propulsion system 109 or brake system 112 to move the fuel efficiency toward a fuel efficiency target that also moves the generation of emissions away from an emission generation target. Additionally or alternatively, referring to the Equation Eq. 1, changing one or more other coefficients, such as the coefficient α2 referencing the horse power rate of change or the coefficient α3 representing the travel time of the vehicle may also change the amount of emissions generated by the vehicle 102. For example, the amount of emissions generated by the vehicle may move closer to an emission generation target by moving the travel time of the vehicle 102 away from a travel time target (e.g., the vehicle 102 arrives at the destination late).

The table 600 illustrates one example of the coefficients α1 and α4 having different weights or importance based on the plural different designated conditional states through which the vehicle 102 may travel from a start location to an end location. Additionally or alternatively, the weight of importance given to any of the coefficients α1, α2, α3, α4 may change based on the number of vehicles 102 within the vehicle consist. For example, the coefficient α4 referencing the cumulative generation of emissions may be given a weight for a consist having plural vehicles 102 that is greater than a weight given for a single vehicle 102. In another example, the coefficient α3 representing the travel time may be given a weight that is greater than a weight given to the other coefficients based on the cargo that the vehicle 102 is transporting. For example, the arrival time of the vehicle 102 may be more important than the fuel consumption by the vehicle 102. In another example, the coefficient α4 may be given a weight that is greater than a weight given to each of the other coefficients based on the atmospheric condition of the area through which the vehicle 102 is moving. For example, the vehicle 102 may operate to generate fewer emissions when the vehicle 102 is moving within a geographic area during rush hour compared to the vehicle 102 moving in a different geographic area, or moving within the same geographic area but not during rush hour.

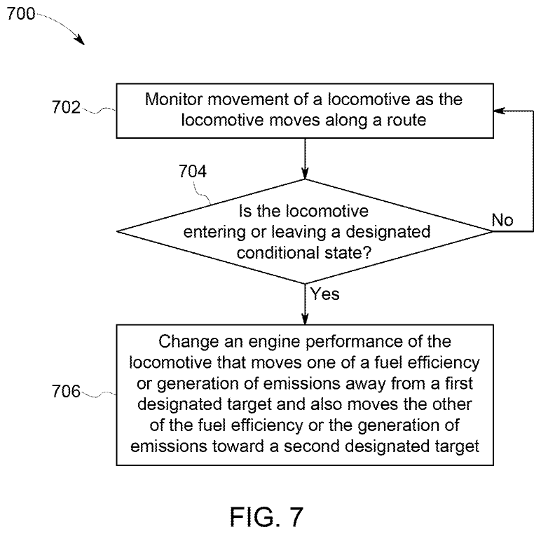

FIG. 7 illustrates a flowchart 700 of one embodiment of a method for controlling the vehicle. At 702, the monitoring system 118 monitors movement of the vehicle 102 as the vehicle 102 moves along the route 106. At 704, the monitoring system 118 determines if the vehicle 102 is entering or leaving a designated conditional state. The designated conditional state may be a geographic area, a time, a day of the week, a date, an atmospheric condition, or the like. If the vehicle 102 is not entering or leaving a designated conditional state, then flow of the method returns to 702 and the monitoring system 118 continues to monitor the movement of the vehicle 102 until the vehicle 102 has reached the end of the trip. If the vehicle 102 is entering or leaving the designated conditional state, then flow of the method continues to 706.

At 706, responsive to the vehicle 102 entering or leaving the designated conditional state, a control system 101 of the vehicle 102 changes an operation of the vehicle 102 that changes the engine performance of the vehicle 102. In one embodiment, the control system 101 changes one or more settings of the propulsion system 109 or the brake system 112 that moves the fuel efficiency of the vehicle away from a first designated target or a fuel efficiency target and that also moves the generation of emissions toward a second designated target or an emission generation target. For example, the designated conditional state may be a geographic area that has an emissions restriction directed by a governmental agency. As the vehicle 102 moves within the designated conditional state, the vehicle 102 generates a fewer amount of emissions. Instead of reducing the amount of emissions the vehicle generates to an optimized amount, the control system 101 changes to the engine performance just enough to increase the fuel consumption of the vehicle 102 only by just an amount needed to reduce the emissions to the second designated target and no more.

In another embodiment, the control system 101 changes one or more settings of the vehicle 102 that moves the fuel efficiency of the vehicle 102 toward the first designated target or the fuel efficiency target and that also moves the generation of emissions away from the second designated target or the emission generation target. For example, the designated conditional state may be a different geographic area that includes a speed limit. As the vehicle 102 moves within the designated conditional state, the vehicle 102 burns less fuel and moves the fuel efficiency of the vehicle toward the fuel efficiency target. Instead of reducing the speed of the vehicle 102 to consume an optimized reduced amount of fuel (e.g., operate the most fuel efficiently), the control system 101 changes the engine performance to increase the generation of emissions by an amount needed to reduce the fuel consumption to the first designated target and no more.

In order to change an operation of the vehicle 102 that changes the engine performance of the vehicle 102 at 706, in one example, the control system 101 determines a fuel efficiency weight and an emission generation weight based on the designated conditional state. In one example the fuel efficiency weight and emission generation weight are provided in a look up table where the designated conditional state is a geographic location of being with a state and each weight is related to regulations of the state.

In one embodiment of the subject matter described herein, a method for controlling a vehicle includes monitoring movement of the vehicle as the vehicle moves along a route, and determining when the vehicle enters or leaves a designated conditional state. Responsive to the vehicle entering or leaving the designated conditional state, the method also includes changing an engine performance of the vehicle that moves one of a fuel efficiency of the vehicle or generation of an emission constituent of the vehicle away from a first designated target, and that also moves the other of the fuel efficiency of the vehicle or the generation of the emission constituent toward a second designated target.

Optionally, in one embodiment of the subject matter described herein, a method for controlling a vehicle includes monitoring movement of a vehicle as the vehicle moves along a route and determining when the vehicle enters or leaves a designated conditional state. Responsive to the vehicle entering or leaving the designated conditional state, the method includes controlling an engine system of the vehicle so that: (i) one of a fuel efficiency of the vehicle is decreased or generation of an emission constituent of the vehicle is increased, and concurrently (ii) the other of the fuel efficiency of the vehicle is increased or the generation of the emission constituent is decreased.

Optionally, changing the engine performance includes moving the fuel efficiency away from the first designated target by increasing fuel consumption of the vehicle and moving the generation of the emission constituent toward the second designated target by reducing the generation of the emission constituent of the vehicle.

Optionally, changing the engine performance includes moving the fuel efficiency toward the first designated target by decreasing the fuel consumption of the vehicle and moving the generation of the emission constituent away from the second designated target by increasing the generation of the emission constituent.

Optionally, the designated conditional state may be one of a geographic area, a time, a date, or an atmospheric condition.

Optionally, the designated conditional state may be one of several different designated conditional states each associated with one or more of a different first designated target or a different second designated target.

Optionally, in one embodiment a method for controlling a vehicle includes monitoring movement of a vehicle as the vehicle moves along a route and determining when the vehicle enters or leaves any of plural designated conditional states. Responsive to the vehicle entering or leaving one of the plural designated conditional states, the method includes changing an engine performance of the vehicle that moves one of a fuel efficiency of the vehicle or generation of an emission constituent of the vehicle away from a respective first designated target, and that also moves the other of the fuel efficiency of the vehicle or the generation of the emission constituent toward a respective second designated target, the first and second designated targets associated with said one of the plural designated conditional states, and each of the plural designated conditional states having a different first designated target and a different second designated target respectively associated therewith.

Optionally, the different second designated targets include a reduction or increase of one or more of particulate matter, oxide emissions, or sound emissions.

Optionally, the vehicle may be configured to enter into a first designated conditional state as the vehicle moves along the route, wherein the first designated conditional state is associated with a first designated target including an increase in fuel consumption to a first threshold value and a second designated target including a reduction of particulate matter.

Optionally, the vehicle may be configured to leave the first designated conditional state and subsequently enter a second designated conditional state as the vehicle moves along the route, wherein the second designated conditional state is associated with a first designated target including an increase in fuel consumption to a second threshold value that is greater than the first threshold value and a second designated target including a reduction of particulate matter and a reduction of oxide emissions.

Optionally, the vehicle may be configured to leave the second designated conditional state and subsequently enter a third designated conditional state as the vehicle moves along the route, wherein the third designated conditional state may be associated with a first designated target including a reduction in fuel consumption and a second designated target including an increase of oxide emissions.

Optionally, changing the engine performance includes increasing the fuel consumption of the vehicle only by an amount needed to reduce emissions to the second designated target and no more.

Optionally, changing the engine performance includes increasing the generation of the emission constituent only by an amount needed to reduce fuel consumption to the first designated target and no more.

Optionally, changing the engine performance includes moving the fuel efficiency of the vehicle away from the first designated target by decreasing the fuel efficiency of the vehicle.

Optionally, changing the engine performance includes moving the generation of the emission constituent toward the second designated target by decreasing the generation of the emission constituent.

Optionally, the emission constituent may be one or more of particulate matter emissions, oxide emissions, carbon monoxide emissions, or sound emissions.

In one embodiment of the subject matter described herein, a vehicle control system includes a monitoring system configured to monitor movement of a vehicle as the vehicle moves along a route. The monitoring system may be configured to determine when the vehicle enters or leaves a designated conditional state. A control system may be configured to control engine performance of the vehicle. Responsive to the monitoring system determining when the vehicle enters or leaves the designated conditional state, the control system may be configured to change the engine performance of the vehicle that moves one of a fuel efficiency of the vehicle or generation of an emission constituent of the vehicle away from a first designated target, and that also moves the other of the fuel efficiency of the vehicle or the generation of the emissions constituent toward a second designated target.

Optionally, the control system may be configured to change the engine performance to move the fuel efficiency of the vehicle away from the first designated target by increasing fuel consumption of the vehicle and also to move the generation of the emission constituent toward the second designated target by reducing the generation of the emission constituent of the vehicle.

Optionally, the control system may be configured to change the engine performance to move the fuel efficiency of the vehicle toward the first designated target by decreasing fuel consumption of the vehicle and also to move the generation of the emission constituent away from the second designated target by increasing the generation of the emission constituent of the vehicle.

Optionally, the designated conditional state may be one or more of a geographic area, a time, a date, or an atmospheric condition.

Optionally, the designated conditional state may be one of several different designated conditional states each associated with one or more of a different first designated target or a different second designated target.

Optionally, the different second designated targets includes a reduction or increase of one or more of particulate matter, oxide emissions, or sound emissions.

Optionally, the vehicle may be configured to enter into a first designated conditional state as the vehicle moves along the route, wherein the first designated conditional state may be associated with a first designated target including an increase in fuel consumption to a first threshold value and a second designated target including a reduction of particulate matter.

Optionally, the vehicle may be configured to leave the first designated conditional state and subsequently enter a second designated conditional state as the vehicle moves along the route, wherein the second designated conditional state may be associated with a first designated target including an increase in fuel consumption to a second threshold value that is greater than the first threshold value and a second designated target including a reduction of particulate matter and a reduction of oxide emissions.

Optionally, the vehicle may be configured to leave the second designated conditional state and subsequently enter a third designated conditional state as the vehicle moves along the route, wherein the third designated conditional state is associated with a first designated target including a reduction in fuel consumption and a second designated target including an increase of oxide emissions.

Optionally, the control system may be configured to change the engine performance by increasing the fuel consumption of the vehicle only by an amount needed to reduce emissions to the second designated target and no more.

Optionally, the control system may be configured to change the engine performance by increasing the generation of the emission constituent only by an amount needed to reduce fuel consumption to the first designated target and no more.

Optionally, the control system may be configured to change the engine performance to move the fuel efficiency of the vehicle away from the first designated target by decreasing the fuel efficiency of the vehicle.

Optionally, the control system may be configured to change the engine performance to move the generation of the emission constituent toward the second designated target by decreasing the generation of the emission constituent.

Optionally, the emission constituent may be one or more of particulate matter emissions, oxide emissions, carbon monoxide emissions, or sound emissions.

In one embodiment of the subject matter described herein, a method for controlling a vehicle includes monitoring movement of the vehicle as the vehicle moves along a route, and determining when the vehicle enters or leaves a designated conditional state. Responsive to the vehicle entering or leaving the designated conditional state, the method also includes changing an engine performance of the vehicle that moves one of a fuel efficiency of the vehicle or generation of an emission constituent of the vehicle away from a first designated target, and that also moves the other of the fuel efficiency of the vehicle or the generation of the emission constituent toward a second designated target. Changing the engine performance includes moving the fuel efficiency away from the first designated target by increasing fuel consumption of the vehicle and moving the generation of the emission constituent toward the second designated target by reducing the generation of the emission constituent of the vehicle.

In one or more embodiments a method for controlling a vehicle may be provided that may include monitoring movement of a vehicle as the vehicle moves along a route, determining when the vehicle enters or leaves a first designated conditional state, and determining a first fuel efficiency weight and a first emission generation weight based on the first designated conditional state. Responsive to the vehicle entering or leaving the first designated conditional state, the method may include changing engine performance of the vehicle based on the first fuel efficiency weight and the first emission generation weight.

Optionally, changing the engine performance may include moving fuel efficiency away from a first fuel efficiency target by increasing fuel consumption of the vehicle and moving a generation of an emission constituent toward a first emission generation target by reducing the generation of the emission constituent of the vehicle. Alternatively, changing the engine performance includes moving the fuel efficiency toward the first fuel efficiency target by decreasing fuel consumption of the vehicle and moving the generation of the emission constituent away from the first emission generation target by increasing the generation of the emission constituent of the vehicle.

Optionally, the designated conditional state may be one or more of a geographic area, a time, a date, or an atmospheric condition.

Optionally to change engine performance includes a reduction or increase of one or more of particulate matter, oxide emissions, carbon monoxide emissions, or sound emissions.

Optionally the method may also include determining when the vehicle enters or leaves a second designated conditional state, determining a second fuel efficiency weight and a second emission generation weight based on the second designated conditional state, and responsive to the vehicle entering or leaving the second designated conditional state, changing the engine performance of the vehicle that moves the fuel efficiency of the vehicle toward or away from a second fuel efficiency target based on the second fuel efficiency weight, and moves the generation of the emission constituent of the vehicle toward or away from a second emission generation target based on the second emission generation weight.

Optionally, the first fuel efficiency weight may be different than the second fuel efficiency weight, or the first emission generation weight may be different than the second emission generation weight.

Optionally, the method may include automatically stopping reduction in the generation of the emission constituent of the vehicle upon reaching the first emission generation target.

In one or more embodiments a vehicle control system may be provided that may include a monitoring system configured to monitor movement of a vehicle as the vehicle moves along a route, wherein the monitoring system may be configured to determine when the vehicle enters or leaves a first designated conditional state. A control system may be configured to control engine performance of the vehicle, wherein responsive to the monitoring system determining when the vehicle enters or leaves the first designated conditional state, the control system may be configured to determine a first fuel efficiency weight and a second emission generation weight based on the first designated conditional state. The control system may also be configured to change the engine performance of the vehicle based on the first fuel efficiency weight and the first emission generation weight.

Optionally, the control system may be configured to change the engine performance to move fuel efficiency of the vehicle away from a first fuel efficiency target by increasing fuel consumption of the vehicle, and to concurrently move a generation of the emission constituent toward a first emission generation target by reducing the generation of the emission constituent of the vehicle.

Optionally, the control system may be configured to change the engine performance to move the fuel efficiency of the vehicle toward the first fuel efficiency target by decreasing fuel consumption of the vehicle, and to concurrently move the generation of the emission constituent away from the first emission generation target by increasing the generation of the emission constituent of the vehicle.

Optionally, the designated conditional state may be one or more of a geographic area, a time, a date, or an atmospheric condition.

Optionally, the vehicle control system may also be configured to determine when the vehicle enters or leaves a second designated conditional state, and determine a second fuel efficiency weight and a second emission generation weight based on the second designated conditional state. The vehicle control system may also be configure to, responsive to the vehicle entering or leaving the second designated conditional state, change the engine performance of the vehicle that moves the fuel efficiency of the vehicle toward or away from a second fuel efficiency target based on the second fuel efficiency weight, and moves the generation of the emission constituent of the vehicle toward or away from a second emission generation target based on the second emission generation weight.

Optionally, the first fuel efficiency weight may be different than the second fuel efficiency weight, or the first emission generation weight may be different than the second emission generation weight.

Optionally, the control system may be configured to determine a first fuel consumption threshold based on the first designated conditional state, and determine a second fuel consumption threshold based the second designated conditional state, and wherein the first fuel consumption threshold is greater than the second fuel consumption threshold.

Optionally, the control system may be configured to stop reduction in the generation of the emission constituent of the vehicle upon reaching the first emission generation target.

Optionally, the emission constituent may be one or more of particulate matter emissions, oxide emissions, carbon monoxide emissions, or sound emissions.

In one or more embodiments, a method for controlling a vehicle may be provided that may include monitoring movement of a vehicle as the vehicle moves along a route, and determining when the vehicle enters or leaves a designated conditional state, the designated conditional state including one or more of a geographic area, a time, a date, or an atmospheric condition. The method may also include determining a fuel efficiency weight and an emission generation weight based on the first designated conditional state, and responsive to the vehicle entering or leaving the designated conditional state, changing engine performance of the vehicle based on the fuel efficiency weight and the emission generation weight. Changing the engine performance may include moving fuel efficiency away from a first designated target by increasing fuel consumption of the vehicle and moving a generation of the emission constituent toward a second designated target by reducing the generation of the emission constituent of the vehicle.

Optionally, the method may also include determining a fuel consumption threshold based on the fuel efficiency weight, and preventing fuel consumption from reducing past the fuel consumption threshold during or within the designated conditional state.

Optionally, the method may also include determining an emission generation threshold based on the emission generation weight, and preventing the generation of the emission constituent less than the emission generation threshold during or within the designated conditional state.

As used herein, the terms “processor” and “computer,” and related terms, e.g., “processing device,” “computing device,” and “controller” may be not limited to just those integrated circuits referred to in the art as a computer, but refer to a microcontroller, a microcomputer, a programmable logic controller (PLC), field programmable gate array, and application specific integrated circuit, and other programmable circuits. Suitable memory may include, for example, a computer-readable medium. A computer-readable medium may be, for example, a random-access memory (RAM), a computer-readable non-volatile medium, such as a flash memory. The term “non-transitory computer-readable media” represents a tangible computer-based device implemented for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. As such, the term includes tangible, computer-readable media, including, without limitation, non-transitory computer storage devices, including without limitation, volatile and non-volatile media, and removable and non-removable media such as firmware, physical and virtual storage, CD-ROMS, DVDs, and other digital sources, such as a network or the Internet.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

1. A method comprising:
monitoring movement of a vehicle as the vehicle moves along a route;
determining whether the vehicle enters or leaves a first designated conditional state;
determining a first fuel efficiency weight and a first emission generation weight based on the first designated conditional state; and
responsive to the vehicle entering or leaving the first designated conditional state, changing engine performance of the vehicle based on the first fuel efficiency weight and the first emission generation weight.

2. The method of claim 1, wherein changing the engine performance includes moving fuel efficiency away from a first fuel efficiency target by increasing fuel consumption of the vehicle and moving a generation of an emission constituent toward a first emission generation target by concurrently reducing the generation of the emission constituent of the vehicle.

3. The method of claim 1, wherein changing the engine performance includes moving fuel efficiency toward a first fuel efficiency target by decreasing fuel consumption of the vehicle and moving a generation of an emission constituent away from a first emission generation target by concurrently increasing the generation of the emission constituent of the vehicle.

4. The method of claim 1, wherein the first designated conditional state is one or more of a geographic area, a time, a date, or an atmospheric condition.

5. The method of claim 1, wherein changing the engine performance includes a reduction or increase of one or more of particulate matter, oxide emissions, carbon monoxide emissions, or sound emissions.

6. The method of claim 1, further comprising:
determining when the vehicle enters or leaves a second designated conditional state;
determining a second fuel efficiency weight and a second emission generation weight based on the second designated conditional state; and
responsive to the vehicle entering or leaving the second designated conditional state, changing engine performance of the vehicle based on the second fuel efficiency weight and the second emission generation weight.

7. The method of claim 6, wherein the first fuel efficiency weight is different than the second fuel efficiency weight, or the first emission generation weight is different than the second emission generation weight.

8. The method of claim 1, further comprising determining a first emission generation target based on the first emission generation weight; and automatically stopping a reduction in a generation of an emission constituent of the vehicle upon reaching the first emission generation target.

9. A vehicle control system comprising:
a monitoring system configured to monitor movement of a vehicle as the vehicle moves along a route, wherein the monitoring system is configured to determine when the vehicle enters or leaves a first designated conditional state; and
a control system configured to control engine performance of the vehicle, wherein responsive to the monitoring system determining when the vehicle enters or leaves the first designated conditional state, the control system is configured to:
determine a first fuel efficiency weight and a first emission generation weight based on the first designated conditional state; and
change the engine performance of the vehicle based on the first fuel efficiency weight and the first emission generation weight.

10. The vehicle control system of claim 9, wherein the control system is configured to change the engine performance to move fuel efficiency of the vehicle away from a first fuel efficiency target by increasing fuel consumption of the vehicle, and to concurrently move generation of an emission constituent toward a first emission generation target by reducing the generation of the emission constituent of the vehicle.

11. The vehicle control system of claim 9, wherein the control system is configured to change the engine performance to move fuel efficiency of the vehicle toward a first fuel efficiency target by decreasing fuel consumption of the vehicle, and to concurrently move a generation of an emission constituent away from a first emission generation target by increasing the generation of the emission constituent of the vehicle.

12. The vehicle control system of claim 9, wherein the first designated conditional state is one or more of a geographic area, a time, a date, or an atmospheric condition.

13. The vehicle control system of claim 9, wherein the vehicle control system is further configured to:
determine when the vehicle enters or leaves a second designated conditional state;
determine a second fuel efficiency weight and a second emission generation weight based on the second designated conditional state; and
change the engine performance of the vehicle based on the second fuel efficiency weight and the second emission generation weight.

14. The vehicle control system of claim 13, wherein the first fuel efficiency weight is different than the second fuel efficiency weight, or the first emission generation weight is different than the second emission generation weight.

15. The vehicle control system of claim 13, wherein the control system is further configured to determine a first fuel consumption threshold based on the first designated conditional state, and determine a second fuel consumption threshold based the second designated conditional state, and wherein the first fuel consumption threshold is greater than the second fuel consumption threshold.

16. The vehicle control system of claim 9, wherein the control system is configured to stop reduction in a generation of emission constituent of the vehicle upon reaching a first emission generation target based on the first emission generation weight.

17. The vehicle control system of claim 16, wherein the emission constituent is one or more of particulate matter emissions, oxide emissions, carbon monoxide emissions, or sound emissions.

18. A method for controlling a vehicle comprising:
monitoring movement of a vehicle as the vehicle moves along a route;
determining when the vehicle enters or leaves a designated conditional state, the designated conditional state including one or more of a geographic area, a time, a date, or an atmospheric condition;
determining a fuel efficiency weight and an emission generation weight based on the designated conditional state; and
responsive to the vehicle entering or leaving the designated conditional state, changing engine performance of the vehicle based on the fuel efficiency weight and the emission generation weight;
wherein changing the engine performance includes moving fuel efficiency away from a first designated target by increasing fuel consumption of the vehicle and moving a generation of an emission constituent toward a second designated target by reducing the generation of the emission constituent of the vehicle.

19. The method of claim 18, further comprising:
determining a fuel consumption threshold based on the fuel efficiency weight; and
preventing fuel consumption from reducing past the fuel consumption threshold during or within the designated conditional state.

20. The method of claim 19, further comprising:
determining an emission generation threshold based on the emission generation weight; and
preventing the generation of the emission constituent less than the emission generation threshold during or within the designated conditional state.
